(19) United States
(12) Patent Application Publication
(10) Pub. No.: US 2011/0258086 A1
(43) Pub. Date: Oct. 20, 2011

(54) COMPUTER INTERFACE FOR ONLINE COMMERCE WITH COMMUNITY FEATURES

(75) Inventor: Jeanine Stein, Palo Alto, CA (US)

(73) Assignee: Select2gether, Inc., San Francisco, CA (US)

(21) Appl. No.: 13/072,186

(22) Filed: Mar. 25, 2011

Related U.S. Application Data
(60) Provisional application No. 61/318,018, filed on Mar. 26, 2010.

(51) Int. Cl. G06Q 30/00

(52) U.S. Cl. 705/27.2

(57) ABSTRACT

Disclosed herein, in certain embodiments, are computer-implemented methods for interactive social shopping wherein multiple users are able to interact in real time and simultaneously view an identical item for purchase. Further disclosed herein, are systems for interactive social shopping wherein multiple users are able to interact in real time and simultaneously view an identical item for purchase. Additionally disclosed herein, are devices that enable interactive social shopping wherein multiple users are able to interact in real time and simultaneously view an identical item for purchase.

### CROSS-REFERENCE

This application claims the benefit of U.S. Provisional Application No. 61/318,018, filed Mar. 26, 2010, which application is incorporated herein by reference in its entirety.

### BACKGROUND OF THE INVENTION

Disclosed herein, in certain embodiments, is a computer-implemented method for interactive social shopping, comprising: (a) a first user and a second user launching an interactive social shopping user interface, provided by a social shopping networking service; (b) the first user and the second user simultaneously or near simultaneously viewing a graphic representation of at least one identical item for purchase such that a live showroom is generated, wherein the at least one item for purchase is provided by the interactive social shopping user interface; and (c) the first user and the second user interacting with each other, wherein the interaction is through an interacting computer module (e.g., a computer program) provided by the interactive social shopping user interface.

Disclosed herein, in certain embodiments, is a computer-implemented method for interactive social shopping, comprising: (a) a social shopping networking service providing an interactive social shopping user interface to at least a first user and a second user; and (b) the interactive social shopping user interface providing to the first user and the second user (i) a computer module (e.g., a computer program) that provides a selection of items for purchase, (ii) a computer module (e.g., a computer program) that enables the first user and the second user to simultaneously view a graphic representation of an item for purchase, and (iii) a computer module (e.g., a computer program) that enables at least the first user and the second user to interact with each other. In some embodiments, (a) the first user launches the interactive social shopping user interface from a first computer and the second user launches the interactive social shopping user interface from a second computer; (b) the first user and the second user simultaneously view at least one identical item for purchase from the selection provided by the interactive social shopping user interface, such that a live showroom is generated; and (c) the first user and the second user interact with each other in real time.

Additionally disclosed herein, in certain embodiments, is a system for interactive social shopping, comprising: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

Further disclosed herein, in certain embodiments, is a device for interactive social shopping, the device comprising: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

Disclosed herein, in certain embodiments is a computer-implemented method for interactive social shopping, comprising: (a) a social shopping networking service providing an interactive social shopping user interface to at least a first user and a second user; (b) the interactive social shopping user interface providing to the first user and the second user (i) a computer module (e.g., a computer program) that provides a selection of items for purchase, (ii) a computer module (e.g., a computer program) that enables the first user and the second user to simultaneously view a graphic representation of an item for purchase, and (iii) a computer module (e.g., a computer program) that enables at least the first user and the second user to interact with each other; and (c) the first user and the second user launching the interactive social shopping user interface. In some embodiments, the first user launches the interactive social shopping user interface from a first computer and the second user launches the interactive social shopping user interface from a second computer; the first user and the second user simultaneously view at least one identical item for purchase from the selection provided by the interactive social shopping user interface, such that a live showroom is generated; and the first user and the second user interact with each other in real time. In some embodiments, the method further comprises the interactive social shopping user interface generating a list of items for purchase by analyzing the previous purchases of the first user or the second user. In some embodiments, the method further comprises the interactive social shopping user interface generating a list of items for purchase by analyzing the previous items for purchase viewed by the first user or the second user. In some embodiments, the graphic representation of at least one item for purchase is a photograph. In some embodiments, the graphic representation of at least one item for purchase further comprises a graphic representation of the first user or the second user. In some embodiments, the graphic representation of at least one item for purchase is a 3-dimensional graphic representation. In some embodiments, the graphic representation of at least one item for purchase is a 2-dimensional graphic representation. In some embodiments, the item for purchase is controlled by a vendor. In some embodiments, the vendor manufactures the item for purchase or is a reseller of the item for purchase. In some embodiments, the second user is: a vendor representative, a personal shopper, a sales consultant, a friend, or a combination thereof. In some embodiments, the method further comprises the first user launching a social shopping toolbar, provided by the social shopping networking service, and populating the toolbar with at least one item for purchase. In some embodiments, the first user contacts the second user by selecting the second user from a menu on the toolbar. In some embodiments, the method further comprises the first user and the second user interacting in real time. In some embodiments, the method further comprises the first user and the second user interacting in non-real time. In some embodiments, the first user and the second user interact by a method selected from: email, webmail, chatting, messaging, instant messaging, posting a message, telephone, internet telephone, or a combination thereof. In some embodiments, the first user provides a graphic representation of an item for purchase to the second user. In some embodiments, the method further comprises the second user recommending an item for purchase to the first interactive user. In some embodiments, the method further comprises the first user exporting the graphic representation of an item for purchase to a third party social interface. In some embodiments, the method further comprises the first user or the second user evaluating (i) an item for purchase, (ii) a vendor, or (iii) a combination thereof. In some embodiments, the first user or the second user numerically ranks, positionally ranks, or reviews an item for purchase, a vendor, or a combination thereof. In some embodiments, the method further comprises the first user or the second user modifying a graphic representation of at least one item for purchase. In some embodiments, the first user or the second user modifies the graphic representation of at least one item for purchase by changing the color of the graphic representation of at least one item for purchase. In some embodiments, the first user or the second user modifies the graphic representation of at least one item for purchase by adding an item to the graphic representation of at least one item for purchase. In some embodiments, the item for purchase is a first piece of clothing and the first user or the second user modifies the graphic representation of the first piece of clothing by adding a second piece of clothing to the graphic representation of the first piece of clothing. In some embodiments, the item for purchase is a first piece of clothing and the first user or the second user modifies the graphic representation of the first piece of clothing by adding an accessory to the graphic representation of the first piece of clothing. In some embodiments, the method further comprises the first user or the second user purchasing at least one item for purchase. In some embodiments, the method further comprises the first user or the second user purchasing a plurality of items for purchase. In some embodiments, the method further comprises the first user or the second user purchasing a plurality of items for purchase from a plurality of vendors. In some embodiments, the method further comprises the first user or the second user searching for an item for purchase, wherein the searching is through a searching computer module (e.g., a computer program) provided by the interactive social shopping user interface. In some embodiments, the search term is a designer, a manufacturer, a vendor, a color, a size, a price, a class of items for purchase, a numerical rating, a positional rating, or a combination thereof. In some embodiments, the method further comprises the interactive social shopping user interface notifying the first user or the second user of a sale. In some embodiments, the method further comprises the interactive social shopping user interface notifying the first user or the second user of a coupon or discount code. In some embodiments, the method further comprises the interactive social shopping user interface notifying the first user or the second user of a new item for purchase. In some embodiments, the method further comprises the first user or the second user customizing the interactive social shopping user interface by inputting information. In some embodiments, the first user or the second user inputs a shipping address. In some embodiments, the first user or the second user inputs a billing address. In some embodiments, the first user or the second user inputs a method of payment. In some embodiments, the first user or the second user inputs physical characteristics. In some embodiments, the first user or the second user inputs physical characteristics selected from: physical measurements, gender, age, or a combination thereof. In some embodiments, the first user or the second user inputs clothing sizes. In some embodiments, the first user or the second user inputs shoes sizes. In some embodiments, the first user or the second user inputs accessory sizes. In some embodiments, the first user or the second user inputs style preferences. In some embodiments, the first user or the second user inputs color preferences. In some embodiments, the first user or the second user inputs brand preferences.

Disclosed herein, in certain embodiments is a computer-implemented method for interactive social shopping, comprising: (a) a first user and a second user launching an interactive social shopping user interface, provided by a social shopping networking service; (b) the first user and the second user simultaneously or near simultaneously viewing a graphic representation of at least one identical item for purchase such that a live showroom is generated, wherein the at least one item for purchase is provided by the interactive social shopping user interface; and (c) the first user and the second user interacting with each other, wherein the interaction is through an interacting computer module (e.g., a computer program) provided by the interactive social shopping user interface. In some embodiments, the first user launches the interactive social shopping user interface from a first computer and the second user launches the interactive social shopping user interface from a second computer; the first user and the second user simultaneously view at least one identical item for purchase from the selection provided by the interactive social shopping user interface, such that a live showroom is generated; and the first user and the second user interact with each other in real time. In some embodiments, the method further comprises the interactive social shopping user interface generating a list of items for purchase by analyzing the previous purchases of the first user or the second user. In some embodiments, the method further comprises the interactive social shopping user interface generating a list of items for purchase by analyzing the previous items for purchase viewed by the first user or the second user. In some embodiments, the graphic representation of at least one item for purchase is a photograph. In some embodiments, the graphic representation of at least one item for purchase further comprises a graphic representation of the first user or the second user. In some embodiments, the graphic representation of at least one item for purchase is a 3-dimensional graphic representation. In some embodiments, the graphic representation of at least one item for purchase is a 2-dimensional graphic representation. In some embodiments, the item for purchase is controlled by a vendor. In some embodiments, the vendor manufactures the item for purchase or is a reseller of the item for purchase. In some embodiments, the second user is: a vendor representative, a personal shopper, a sales consultant, a friend, or a combination thereof. In some embodiments, the method further comprises the first user launching a social shopping toolbar, provided by the social shopping networking service, and populating the toolbar with at least one item for purchase. In some embodiments, the first user contacts the second user by selecting the second user from a menu on the toolbar. In some embodiments, the method further comprises the first user and the second user interacting in real time. In some embodiments, the method further comprises the first user and the second user interacting in non-real time. In some embodiments, the first user and the second user interact by a method selected from: email, webmail, chatting, messaging, instant messaging, posting a message, telephone, internet telephone, or a combination thereof. In some embodiments, the first user provides a graphic representation of an item for purchase to the second user. In some embodiments, the method further comprises the second user recommending an item for purchase to the first interactive user. In some embodiments, the method further comprises the first user exporting the graphic representation of an item for purchase to a third party social interface. In some embodiments, the method further comprises the first user or the second user evaluating (i) an item for purchase, (ii) a vendor, or (iii) a combination thereof. In some embodiments, the first user or the second user numerically ranks, positionally ranks, or reviews an item for purchase, a vendor, or a combination thereof. In some embodiments, the method further comprises the first user or the second user modifying a graphic representation of at least one item for purchase. In some embodiments, the first user or the second user modifies the graphic representation of at least one item for purchase by changing the color of the graphic representation of at least one item for purchase. In some embodiments, the first user or the second user modifies the graphic representation of at least one item for purchase by adding an item to the graphic representation of at least one item for purchase. In some embodiments, the item for purchase is a first piece of clothing and the first user or the second user modifies the graphic representation of the first piece of clothing by adding a second piece of clothing to the graphic representation of the first piece of clothing. In some embodiments, the item for purchase is a first piece of clothing and the first user or the second user modifies the graphic representation of the first piece of clothing by adding an accessory to the graphic representation of the first piece of clothing. In some embodiments, the method further comprises the first user or the second user purchasing at least one item for purchase. In some embodiments, the method further comprises the first user or the second user purchasing a plurality of items for purchase. In some embodiments, the method further comprises the first user or the second user purchasing a plurality of items for purchase from a plurality of vendors. In some embodiments, the method further comprises the first user or the second user searching for an item for purchase, wherein the searching is through a searching computer module (e.g., a computer program) provided by the interactive social shopping user interface. In some embodiments, the search term is a designer, a manufacturer, a vendor, a color, a size, a price, a class of items for purchase, a numerical rating, a positional rating, or a combination thereof. In some embodiments, the method further comprises the interactive social shopping user interface notifying the first user or the second user of a sale. In some embodiments, the method further comprises the interactive social shopping user interface notifying the first user or the second user of a coupon or discount code. In some embodiments, the method further comprises the interactive social shopping user interface notifying the first user or the second user of a new item for purchase. In some embodiments, the method further comprises the first user or the second user customizing the interactive social shopping user interface by inputting information. In some embodiments, the first user or the second user inputs a shipping address. In some embodiments, the first user or the second user inputs a billing address. In some embodiments, the first user or the second user inputs a method of payment. In some embodiments, the first user or the second user inputs physical characteristics. In some embodiments, the first user or the second user inputs physical characteristics selected from: physical measurements, gender, age, or a combination thereof. In some embodiments, the first user or the second user inputs clothing sizes. In some embodiments, the first user or the second user inputs shoes sizes. In some embodiments, the first user or the second user inputs accessory sizes. In some embodiments, the first user or the second user inputs style preferences. In some embodiments, the first user or the second user inputs color preferences. In some embodiments, the first user or the second user inputs brand preferences.

Disclosed herein, in certain embodiments, is a system for interactive social shopping, comprising: a computer module (e.g., a computer program) that provides a selection of items for purchase, wherein each item is represented by a graphical representation; a computer module (e.g., a computer program) that enables at least a first and a second user to simultaneously view an identical item for purchase, such that a live showroom is generated; and a computer module (e.g., a computer program) that enables the first and second user to interact with each other. In some embodiments, the computer module (e.g., a computer program) that provides a selection of items for purchase generates a selection of items for purchase by analyzing the previous purchases of the first or second user. In some embodiments, the computer module (e.g., a computer program) that provides a selection of items for purchase generates a selection of items for purchase by purchase by analyzing the previous items for purchase viewed by the first or second user. In some embodiments, the system further comprises a computer module (e.g., a computer program) that enables the first and second user to evaluate an item for purchase, a vendor, or a combination thereof. In some embodiments, the system further comprises a computer module (e.g., a computer program) that enables the first and second user to modify a graphic representation of at least one item for purchase. In some embodiments, the system further comprises a computer module (e.g., a computer program) that enables the first and second user to purchase an item for purchase. In some embodiments, the system further comprises a computer module (e.g., a computer program) that enables the first and second user to search for an item for purchase. In some embodiments, the system further comprises a computer module (e.g., a computer program) that notifies the first and second user of a sale, a coupon, a discount code, a promotion, a new item for purchase, or a combination thereof. In some embodiments, the system further comprises a computer module (e.g., a computer program) that enables the first and second user to calendar the date of an upcoming sale, item release, or a combination thereof. In some embodiments, the system further comprises a computer module (e.g., a computer program) that enables the first and second user to enter and store personal information.

Disclosed herein, in certain embodiments, is a device for interactive social shopping, the device comprising: a computer module (e.g., a computer program) that provides a selection of items for purchase, wherein each item is represented by a graphical representation; a computer module (e.g., a computer program) that enables at least a first and a second user to simultaneously view an identical item for purchase, such that a live showroom is generated; and a computer module (e.g., a computer program) that enables the first and second user to interact with each other. In some embodiments, the device is a computer. In some embodiments, the device is a cell phone, a smart phone, a personal digital assistant (PDA), or a combination thereof. In some embodiments, the device further comprises volatile memory, non-volatile memory, or a combination thereof. In some embodiments, the computer module (e.g., a computer program) that provides a selection of items for purchase generates a selection of items for purchase by analyzing the previous purchases of the first or second user. In some embodiments, the computer module (e.g., a computer program) that provides a selection of items for purchase generates a selection of items for purchase by purchase by analyzing the previous items for purchase viewed by the first or second user. In some embodiments, the device further comprises a computer module (e.g., a computer program) that enables the first and second user to evaluate an item for purchase, a vendor, or a combination thereof. In some embodiments, the device further comprises a computer module (e.g., a computer program) that enables the first and second user to modify a graphic representation of at least one item for purchase. In some embodiments, the device further comprises a computer module (e.g., a computer program) that enables the first and second user to purchase an item for purchase. In some embodiments, the device further comprises a computer module (e.g., a computer program) that enables the first and second user to search for an item for purchase. In some embodiments, the device further comprises a computer module (e.g., a computer program) that notifies the first and second user of a sale, a coupon, a discount code, a promotion, a new item for purchase, or a combination thereof. In some embodiments, the device further comprises a computer module (e.g., a computer program) that enables the first and second user to calendar the date of an upcoming sale, item release, or a combination thereof. In some embodiments, the device further comprises a computer module (e.g., a computer program) that enables the first and second user to enter and store personal information.

Disclosed herein, in certain embodiments, is a business method comprising: collecting commission for a sale resulting from interaction of two or more internet users sharing information about a merchandise available on line.

Disclosed herein, in certain embodiments, is a business method comprising licensing to an online merchant a web application that allows two or more users to exchange information about a merchandise available on line by the online merchant.

Disclosed herein, in certain embodiments, is a web application that allows a user to shop at a plurality of different websites each having different field requirements for completing a sale or an on-line merchandise, wherein the web application automatically populates all relevant information for completing the sale. In some embodiments, the fields include at least 1, 2, 5, or 10 of the following field requirements: name, address, shipping address, credit card information, shirt size, pant size, height, weight, bust size, coupon information, birth date, shoe size, or a combination thereof.

Disclosed herein, in certain embodiments, is a computer-implemented method for creating a social shopping networking service, comprising: providing a first user with a computer program including executable instructions that create a social shopping toolbar comprising a module adapted to create a selection of items from one or more web sites; and providing the first user and at least a second user with a computer program including executable instructions that create a social shopping web application comprising a module adapted to simultaneously view an identical item from the selection of items, such that a live showroom is generated, and a module that enables the users to interact with each other. In some embodiments, the first user selects one or more items by dragging an element of the toolbar and dropping it over an item. In some embodiments, the first user selects one or more items by dragging an item to an element of the toolbar. In some embodiments, the first user selects one or more items by specifying a graphic representation to upload. In some embodiments, the first user selects one or more items by typing a URI. In some embodiments, the selection of items comprises up to 200 items at any given time. In some embodiments, the selection of items comprises up to 100 items at any given time. In some embodiments, the selection of items comprises up to 50 items at any given time. In some embodiments, the interaction between users is initiated by the first user querying at least the second user regarding one or more items from the selection of items.

Disclosed herein, in certain embodiments, is a computer-implemented method for making a web-based purchase, comprising: a first user creating a selection of items from one or more web sites using a social shopping toolbar; the first user querying at least a second user regarding one or more items from the selection of items using the toolbar; the first user and at least the second user simultaneously viewing one or more items from the selection of items using a social shopping web application, such that a live showroom is generated, wherein the toolbar exchanges data with the web application; and any of the users purchasing one or more of the items. In some embodiments, the first user selects one or more items by dragging an element of the toolbar and dropping it over an item. In some embodiments, the first user selects one or more items by dragging an item to an element of the toolbar. In some embodiments, the first user selects one or more items by specifying a graphic representation to upload. In some embodiments, the first user selects one or more items by typing a URI. In some embodiments, the selection of items comprises up to 200 items at any given time. In some embodiments, the selection of items comprises up to 100 items at any given time. In some embodiments, the selection of items comprises up to 50 items at any given time. In some embodiments, the interaction between users is initiated by the first user querying at least the second user regarding one or more items from the selection of items.

Disclosed herein, in certain embodiments, is a computer readable media encoded with a program including instructions executable by the operating system of an optionally networked digital processing device, wherein the instructions create a social shopping networking service comprising: a social shopping toolbar comprising a module adapted to create a selection of items, wherein the items are selected from one or more web sites; and a social shopping web application comprising a module adapted to enable at least a first and a second user to simultaneously view an identical item from the selection of items, such that a live showroom is generated, and a module that enables the first and second user to interact with each other.

Disclosed herein, in certain embodiments, is a computer-based system for social shopping, comprising: (a) a digital processing device comprising an operating system configured to perform executable instructions, wherein the processing device is optionally connected to a computer network; and (b) a computer program including executable instructions that create a social shopping networking service comprising: (i) a social shopping toolbar comprising a module adapted to create a selection of items for purchase, wherein the items are selected from one or more web sites; and (ii) a social shopping web application comprising a module adapted to enable at least a first and a second user to simultaneously view an identical item for purchase from the selection of items for purchase, such that a live showroom is generated, and a module that enables the first and second user to interact with each other. In some embodiments, the toolbar comprises a functional addition to a web browser such as a plug-in, extension, add-in, or add-on. In some embodiments, the toolbar comprises a functional addition to a mobile web browser such as a plug-in, extension, add-in, or add-on. In some embodiments, the toolbar comprises a mobile application. In some embodiments, the toolbar comprises a standalone application. In some embodiments, the toolbar is available to a user when viewing any web site. In some embodiments, the items are text, photographs, videos, hyperlinks, or any combination thereof. In some embodiments, the items are apparel and apparel accessories and the shopping is shopping related. In some embodiments, the toolbar further comprises a module adapted to export one or more items from the selection of items to the social shopping web application. In some embodiments, the toolbar further comprises a module adapted to export one or more items from the selection of items to a third party social network. In some embodiments, the selection of items comprises graphic representations, such as photographs, of the items. In some embodiments, the selection of items comprises URIs of the items. In some embodiments, the module adapted to create a selection of items for purchase generates additions to the selection of items by analyzing the previous items for purchase selected by a user. In some embodiments, the toolbar further comprises a module adapted to search items for purchase previously selected by one or more users from one or more web sites. In some embodiments, the toolbar further comprises a module adapted to monitor the online status of one or more friends or advisors. In some embodiments, the friends or advisors are other users of the social shopping networking service. In some embodiments, the friends or advisors are users of a third party social network. In some embodiments, the toolbar further comprises a module adapted to query one or more friends or advisors regarding one or more items for purchase from the selection of items for purchase. In some embodiments, the toolbar further comprises a module adapted to exchange information with the web application. In some embodiments, the module that enables the first and second user to interact with each other is configured to enable one or more shoppings selected from: email, chat, instant messaging, SMS, MMS, blogging, microblogging, BBS posts, social networking, wall posts, screen sharing, video conferencing, or VoIP.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an embodiment of a live showroom, a selection of items that can be placed in the live showroom, and a selection of users that have launched the interactive social shopping user interface.

FIG. 2 shows an embodiment of a live showroom with several items placed in it.

FIG. 3 shows an embodiment of a computer module (e.g., a computer program) that allows a user to search for specific items for purchase.

FIG. 4 shows an embodiment of a computer module (e.g., a computer program) that allows a user to upload images of owned items.

FIG. 5 shows an embodiment of a computer module (e.g., a computer program) that allows a user to select contacts.

FIG. 6 shows an embodiment of a computer module (e.g., a computer program) that allows a user to communicate with other users in non-real time, receive messages from other users, view contacts, and receive notifications from the social shopping network service.

FIG. 7 shows an embodiment of a webpage for a single item for purchase. The webpage contains information about the item, a link that enables a user to purchase a item, and suggestions of other items the user might like to purchase.

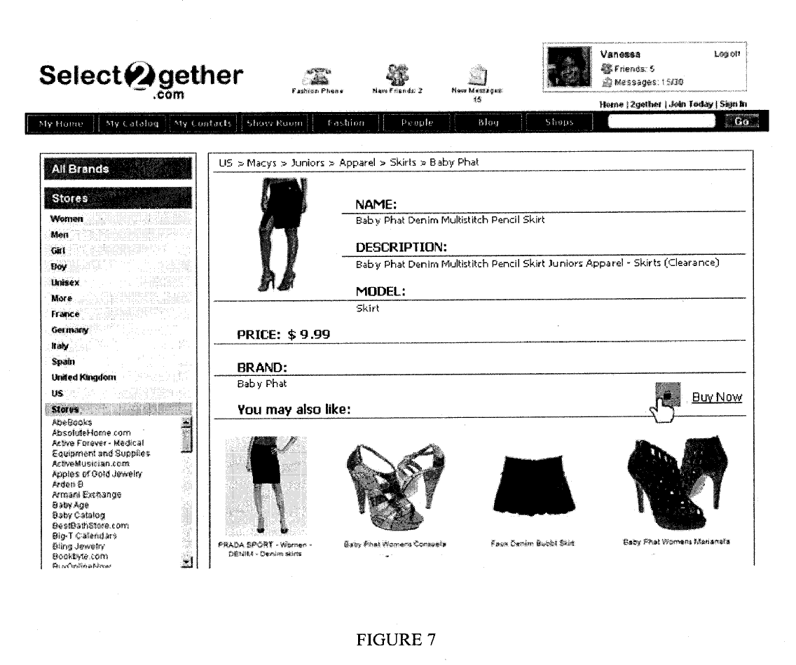

FIG. 8 shows an embodiment of a webpage displaying available brands. A user can click on a brand and several options will appear—sales alerts, popularity ranking, new arrivals, and a calendar of upcoming events associated with the brand.

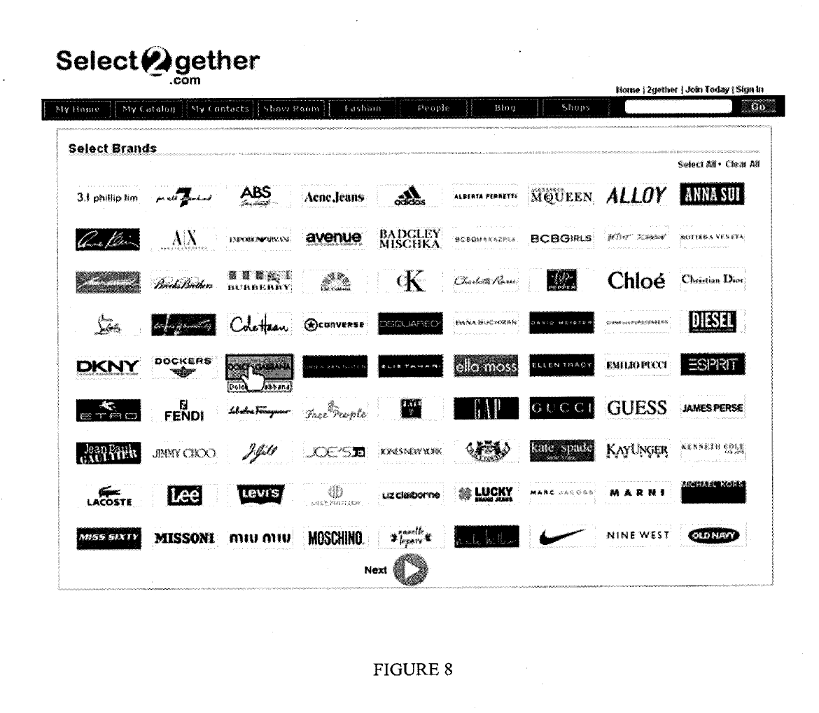

FIG. 9 shows an embodiment of a calendar. This calendar contains sales dates for items of purchase. The figure further shows the ability to send messages to other users.

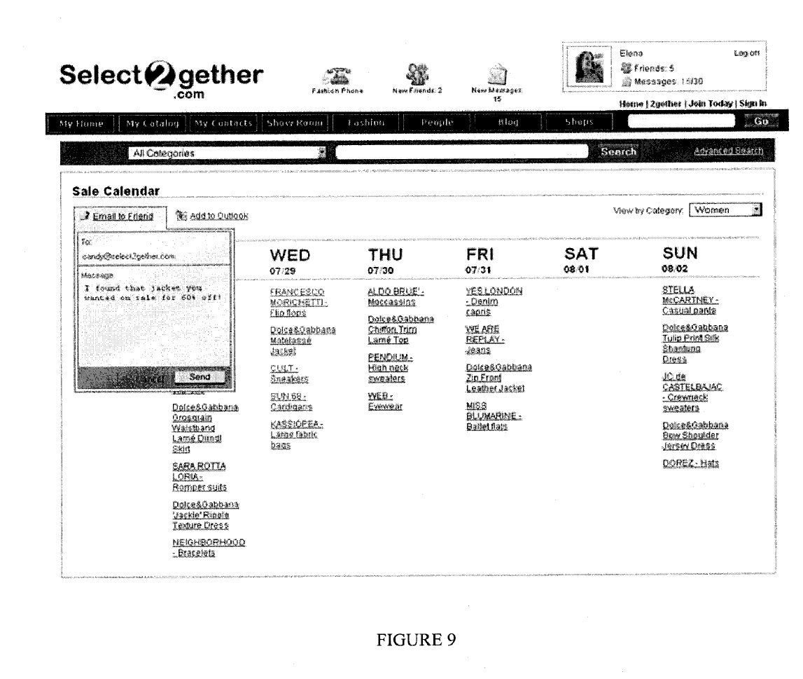

FIG. 10 shows an embodiment of a chat room. The room contains several users discussing an item for purchase (i.e., a purse).

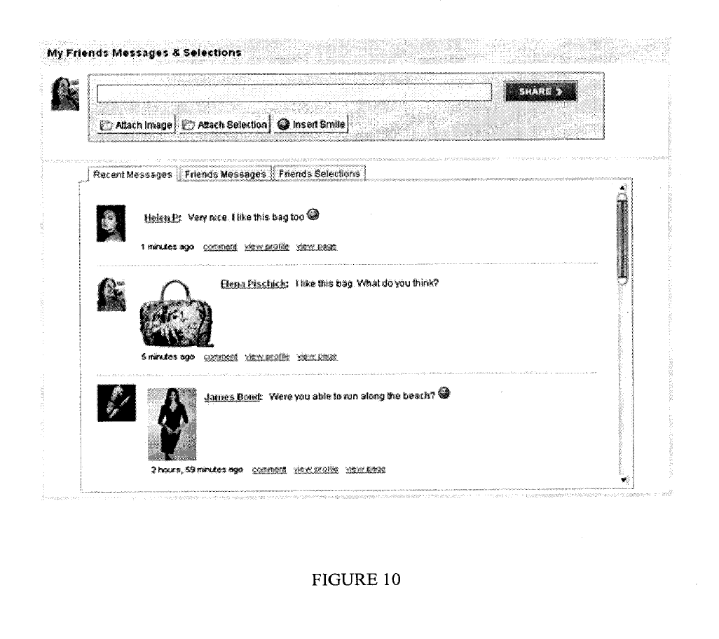

FIG. 11 shows a list of items for purchase sorted by brand. Users are able to rank the items for purchase by filing in a star. Users are able to further sort the items for purchase by ranking. Users are also able to view new arrivals from the brand, sales alerts for the brand, and a calendar with upcoming events associated with the brand.

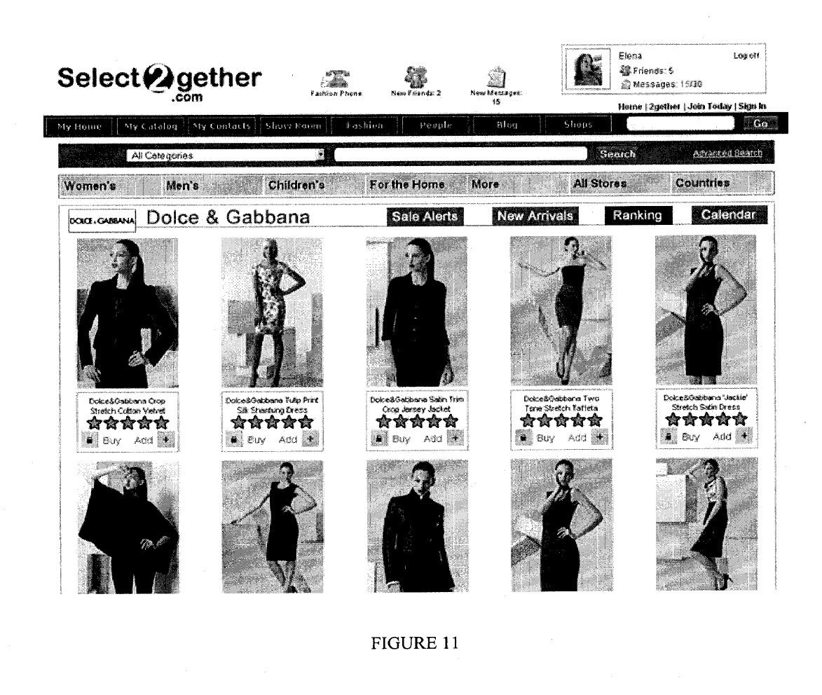

FIG. 12 shows an embodiment of a listing of categories of items for purchase.

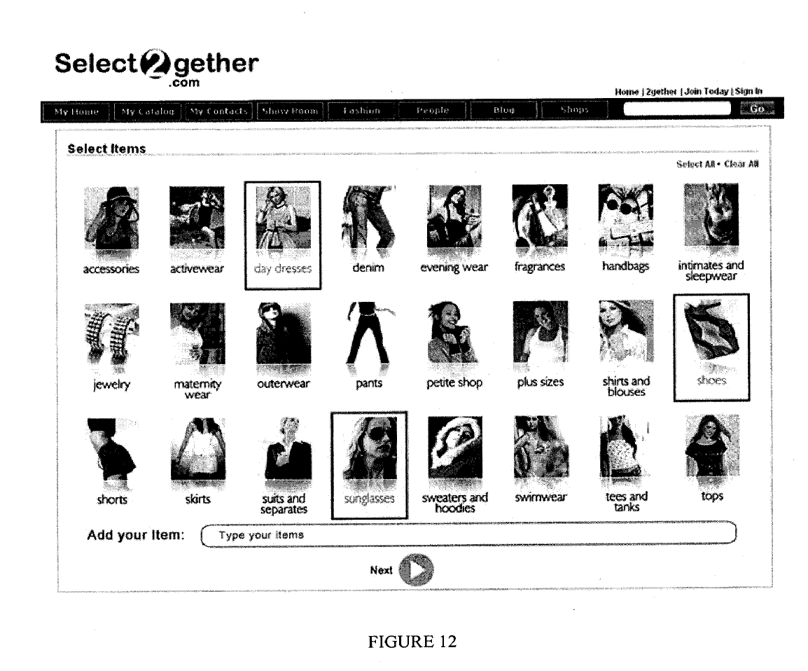

FIG. 13 shows a non-limiting example of a social interaction toolbar; in this case, a social shopping toolbar including a module adapted to create a selection of items from one or more web sites.

FIG. 14 shows a non-limiting example of a social interaction toolbar; in this case, a social shopping toolbar available to a user when viewing any web site including a retail shopping web site.

FIG. 15 shows a non-limiting example of a module adapted to create a selection of items; in this case, a module adapted to export one or more items from said selection of items to said social interaction web application.

FIG. 16 shows a non-limiting example of a module adapted to create a selection of items; in this case, a module further adapted to delete selected items.

FIG. 17 shows a non-limiting example of a module adapted to create a selection of items; in this case, a module further adapted to upload photos of selected items.

FIG. 18 shows a non-limiting example of a module adapted to monitor the online status of one or more friends or advisors; in this case, a module further adapted to monitor friends from a third party social network.

FIG. 19 shows a non-limiting example of a module adapted to query one or more friends or advisors regarding one or more items from a selection of items; in this case, a module further adapted to initiate a live interaction.

FIG. 20 shows a non-limiting example of a social shopping web application; in this case, a web application further comprising a module adapted to query one or more friends or advisors regarding one or more items from a selection of items.

FIG. 21 shows a non-limiting example of a social shopping web application; in this case, a web application further comprising a module adapted to optionally query one or more friends or advisors with specific pre-configured questions regarding one or more items from a selection of items.

FIG. 22 shows a non-limiting example of a module adapted to query one or more friends or advisors regarding one or more items from a selection of items; in this case, a module further adapted to display a message to one or more friends or advisors.

FIG. 23 shows a non-limiting example of a module adapted to query one or more friends or advisors regarding one or more items from a selection of items; in this case, a module further adapted to query other users of the social shopping networking service or a third party social network and initiate a live interaction.

FIG. 24 shows a non-limiting example of a social shopping web application; in this case, an application comprising a module adapted to enable a plurality of users to simultaneously view an identical item from a selection of items, such that a live showroom is generated.

FIG. 25 shows a non-limiting example of a module adapted to search items previously selected by one or more users from one or more web sites; in this case, a module wherein search results are sortable by type of item, brand, discount, or description.

### DETAILED DESCRIPTION

Disclosed herein, in certain embodiments, is a computer-based method that allows people to have a collective virtual shopping experience.

Disclosed herein, in certain embodiments, is a computer-implemented method for interactive social shopping, comprising: (a) a first user and a second user launching an interactive social shopping user interface, provided by a social shopping networking service; (b) the first user and the second user simultaneously or near simultaneously viewing a graphic representation of at least one identical item for purchase such that a live showroom is generated, wherein the at least one item for purchase is provided by the interactive social shopping user interface; and (c) the first user and the second user interacting with each other, wherein the interaction is through an interacting computer module (e.g., a computer program) provided by the interactive social shopping user interface.

Disclosed herein, in certain embodiments, is a computer-implemented method for interactive social shopping, comprising: (a) a social shopping networking service providing an interactive social shopping user interface to at least a first user and a second user; and (b) the interactive social shopping user interface providing to the first user and the second user (i) a computer module (e.g., a computer program) that provides a selection of items for purchase, (ii) a computer module (e.g., a computer program) that enables the first user and the second user to simultaneously view a graphic representation of an item for purchase, and (iii) a computer module (e.g., a computer program) that enables at least the first user and the second user to interact with each other. In some embodiments, (a) the first user launches the interactive social shopping user interface from a first computer and the second user launches the interactive social shopping user interface from a second computer; (b) the first user and the second user simultaneously view at least one identical item for purchase from the selection provided by the interactive social shopping user interface, such that a live showroom is generated; and (c) the first user and the second user interact with each other in real time.

Additionally disclosed herein, in certain embodiments, is a system for interactive social shopping, comprising: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

Further disclosed herein, in certain embodiments, is a device for interactive social shopping, the device comprising: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

### Certain Terminology

As used herein, “shopping” means viewing products, comparing products, discussing product information with others, as well as purchasing products.

As used herein, “computer module (e.g., a computer program)” means a hardware or software component that interacts with a larger system.

As used herein, “software module” means a written program (i.e., computer code, a set of procedures, a set of rules, a logic) pertaining to the operation of a computer system that handles a specific task within a larger software system.

As used herein, “hardware module” means a mechanical, magnetic, electronic, and electrical component of a computer system that is plugged into a main system.

As used herein, “user interface” means the system by which a user interacts with a computer, a server, a program, a social networking service, or a combination thereof.

As used herein, “volatile memory” means computer memory that requires electricity to maintain the stored information.

As used herein, “non-volatile memory” means computer memory that retains the stored information in the absence of electricity.

The terms “products” and “merchandise” may be used interchangeably. Products include, for example, apparel, such as, shoes, bags, clothing, electronic equipment, such as TV's, computers, cameras, cars, books, etc. Products can be new or used. The products described herein are offered for sale on the web or interne. They can be offered for sale by web vendors or merchants (e.g., Amazon.com) or individual (e.g., individuals on eBAY). The products on sale can be new or used.

As used herein, “sales representative” means an individual working for the vendor (e.g., Macy's, Nordstrom's, etc.)

As used herein, a “product advisor” is a third party, affiliated, or not affiliated, with a single vendor. In some embodiments, a product advisor provides general information to a customer about a commercial product and similar, competing products.

### Methods

Disclosed herein, in certain embodiments, is a computer-implemented method for interactive social shopping. In some embodiments, the computer-implemented method is performed by a computer program embodied on a computer readable medium. In some embodiments, the method comprises: (a) a first user and a second user launching (or, logging-on to) an interactive social shopping user interface, provided by a social shopping networking service; (b) the first user and the second user simultaneously or near simultaneously viewing a graphic representation of at least one identical item for purchase such that a live showroom is generated, wherein the at least one item for purchase is provided by the interactive social shopping user interface; and (c) the first user and the second user interacting with each other, wherein the interaction is through an interacting computer module (e.g., a computer program) provided by the interactive social shopping user interface.

Disclosed herein, in certain embodiments, is a computer-implemented method for interactive social shopping, comprising: (a) a social shopping networking service providing an interactive social shopping user interface to at least a first user and a second user; and (b) the interactive social shopping user interface providing to the first user and the second user (i) a computer module (e.g., a computer program) that provides a selection of items for purchase, (ii) a computer module (e.g., a computer program) that enables the first user and the second user to simultaneously view a graphic representation of an item for purchase, and (iii) a computer module (e.g., a computer program) that enables at least the first user and the second user to interact with each other. In some embodiments, (a) the first user launches the interactive social shopping user interface from a first computer and the second user launches the interactive social shopping user interface from a second computer; (b) the first user and the second user simultaneously view at least one identical item for purchase from the selection provided by the interactive social shopping user interface, such that a live showroom is generated; and (c) the first user and the second user interact with each other in real time.

### Users

In some embodiments, the interactive social shopping user interface connects a first user and a second user to the social shopping networking service. In some embodiments, the first user and the second user are members of the social shopping networking service (e.g., establishes a personal account with a log-in and a password). In some embodiments, the first user and the second user are guests (e.g., non-registered users) of the social shopping networking service.

In some embodiments, the first or the second user is: a vendor representative, a personal shopper, a sales consultant, a stylist, a friend, or a combination thereof. In some embodiments, the first or the second user is a vendor representative. In some embodiments, the first or the second user is a personal shopper. In some embodiments, the first or the second user is a sales consultant. In some embodiments, the first or the second user is a stylist. In some embodiments, the first or the second user is a lay person (e.g., a person that is not professionally involved in shopping).

In some embodiments, the first user or the second user is a sales representative or product advisor. In some embodiments, the sales representative or product advisor is asked to join a chat session or interactive session by inviting them from a group of friends, by using a hyperlink from a vendor's website, or by using a hyperlink that offers names of third party vendors. In some embodiments, if a sales representative or advisor is not available, the user clicks on their name sends them a communication (e.g., a non-real time communication) asking for product information.

In some embodiments, a user selects other users with whom to interact. In some embodiments, a user searches for another user. In some embodiments, the social shopping networking service suggests connections between users.

In some embodiments, the first user or the second user invites a contact to join the social networking service. In some embodiments, a user of the social shopping network invites a contact (e.g., from jhop.in, Facebook, Bebo, Twitter, MySpace, LinkedIn, Nexopia, Hi5, StudiVZ, iWiW, Tuenti, Decayenne, Tagged, XING, Badoo, Skyrock, Orkut, Friendster, Mixi, Multiply, Orkut, Wretch, renren, Cyworld) to launch the interactive social shopping interface. In some embodiments, the contact is imported from an electronic address book (e.g., Microsoft Outlook, Gmail, Yahoo mail, AOL email).

### Items for Purchase

Disclosed herein, in certain embodiments, are methods, systems, devices, and software that enables a user to shop for an item for purchase. As used herein, “item for purchase” means any item that is available for purchase. In some embodiments, the item is a piece of clothing. In some embodiments, the item is a book. In some embodiments, the item is a piece of electronic equipment (e.g., a stereo, a computer, a camera, a phone). In some embodiments, the item is a piece of furniture. In some embodiments, the item is a piece of art. In some embodiments, the item is a piece of home decor.

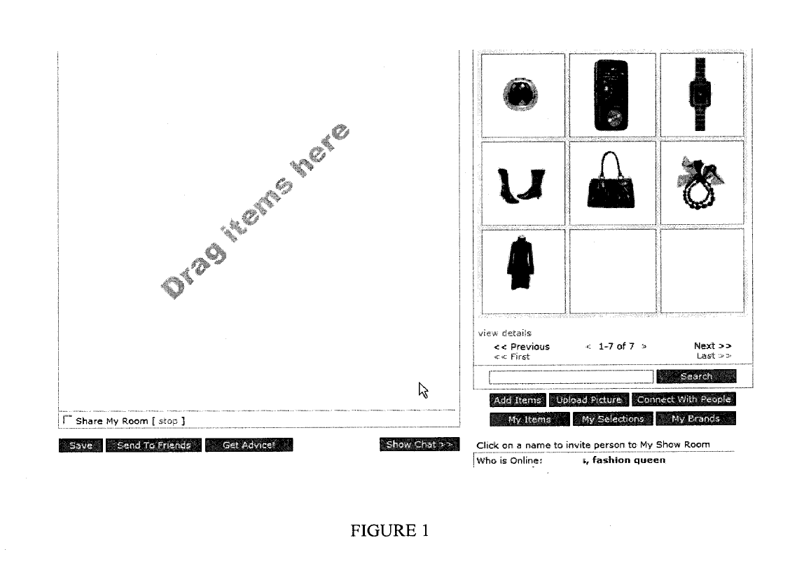

In some embodiments, each item for purchase is represented by a graphic representation. In some embodiments, the graphic representation of at least one item for purchase is a photograph. (See FIG. 1). In some embodiments, the graphic representation is a 3-dimensional graphic representation. In some embodiments, the graphic representation is a 2-dimensional graphic representation. In some embodiments, the graphic representation further comprises a graphic representation (e.g., avatar) of the first user or the second user.

In some embodiments, each item for purchase is associated with a description of the item for purchase. In some embodiments, the description comprises the manufacturer/designer, the vendor, the materials used to make the item for purchase, a manual describing how to use the item for purchase, color options, size options, or a combination thereof. In some embodiments, the description further comprises a computer module (e.g., a computer program) that enables a user to request additional information about the item for purchase.

### Live Showroom

In one embodiment, the web application provides a live showroom. The live showroom is a web portal application that allows one to insert or drag any product selected on the web for the purpose of beginning an interactive shopping session. There are other means for launching an interactive shopping session or Live Showroom, including for example, by clicking or selecting a product in an internet site. FIG. 1 illustrates various items. By dragging the items from the left side of the screen to the right side of the screen the item is immediately displayed by all users in a session, or chat room, or community. The users can then communicate with one another about the one or more products in the display region (left side of screen).

In some embodiments, the social shopping networking service generates a list of items for purchase by analyzing the previous purchases of the first user or the second user. In some embodiments, the social shopping networking service generates a list of items for purchase by analyzing the previous items for purchase viewed by the first user or the second user. In some embodiments, the list of items for purchase is provided to the user through the interactive social shopping interface.

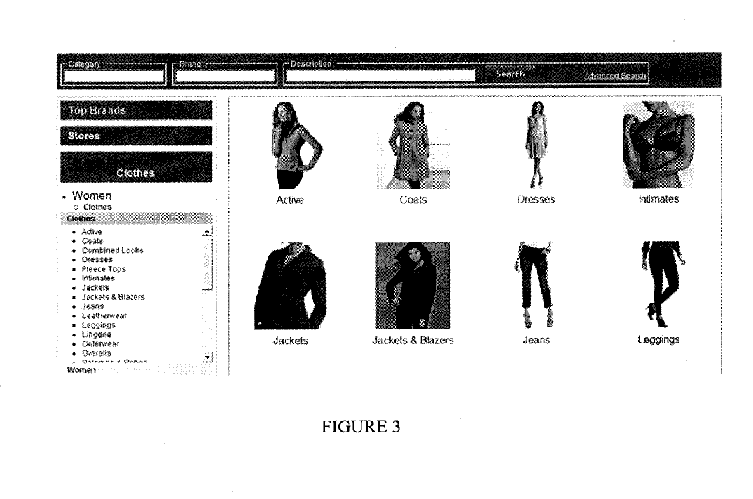

In some embodiments, the first user or the second user searches for an item for purchase, wherein the searching is through a searching computer module (e.g., a computer program) provided by the interactive social shopping user interface. In some embodiments, the search is by a category selected from: designer/manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by two categories selected from: designer/manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by three categories selected from: designer/manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. In some embodiments, the search is by four categories selected from: designer/manufacturer, reseller, color, size, price, class of items (e.g., active, coats, dresses, intimates, jackets, jackets and blazers, jeans, leggings, lingerie, outerwear, pajamas and robes, pants, shirts, shorts, skirts, suits, separates, sweaters, swimwear, T-shirts, tops), numerical rating, positional rating, or a combination thereof. (See FIG. 3).

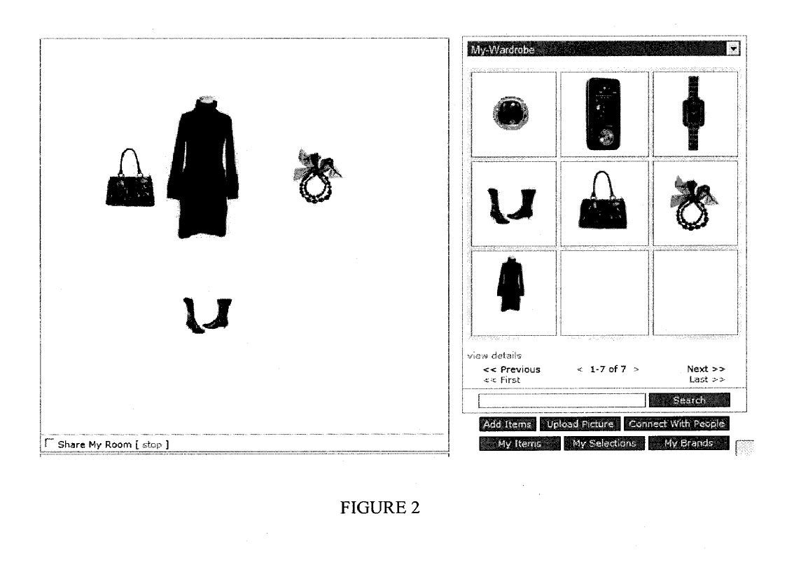

In some embodiments, the first user selects an item for purchase. In some embodiments, the first user contacts the second user and asks the second user to view (and comment on) the item for purchase selected by the first user. In some embodiments, the first user places (e.g., drags) the item into a live showroom that is simultaneously (or near simultaneously) accessible by both the first user and the second. (See FIG. 1 or FIG. 2)

In some embodiments, either the first user or the second user places an additional item into the live showroom. In some embodiments, the items for purchase are combined in a single graphic representation. In some embodiments, individual graphic representations of items for purchase are grouped together. (See FIG. 2) In some embodiments, individual graphic representations of items for purchase are grouped together but not combined into a single graphic representation. (See FIG. 2)

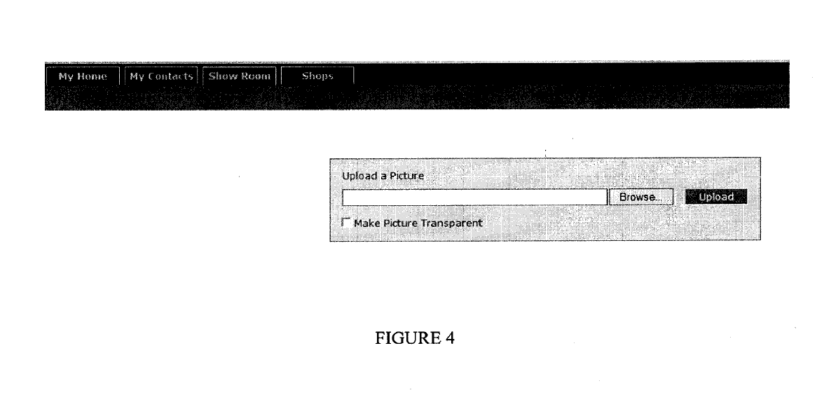

In some embodiments, the method further comprises the first user or the second user uploading a graphic representation of an item already owned (i.e., an owned item) into the live showroom. (See FIGS. 1, 2, and 4) In some embodiments, the first user or the second user combines the graphic representation of the owned item with the graphic representation of an item for purchase. In some embodiments, the items for purchase are combined in a single graphic representation. In some embodiments, individual graphic representations of items for purchase are grouped together. In some embodiments, individual graphic representations of items for purchase are grouped together but not combined into a single graphic representation).

In some embodiments, the method further comprises the first user or the second user modifying a graphic representation of at least one item for purchase. In some embodiments, the first user or the second user modifies the color of the item for purchase, the size of the item for purchase, combines the item for purchase with an additional item for purchase (e.g., a hat, a belt, a pair of shoes, a scarf, a piece of jewelry, or a purse). (See FIG. 2)

In some embodiments, the first user or the second user modifies the graphic representation of at least one item for purchase by changing the color of the graphic representation of at least one item for purchase. By way of non-limiting example, the first user or the second user modifies the color of a shirt from red to pink. In some embodiments, the first user or the second user modifies the graphic representation of at least one item for purchase by adding an item to the graphic representation of at least one item for purchase. (See FIG. 2) By way of non-limiting example, the first user or the second user adds an accessory to the graphic representation.

In some embodiments, the item for purchase is a first piece of clothing and the first user or the second user modifies the graphic representation of the first piece of clothing by adding a second piece of clothing to the graphic representation of the first piece of clothing. By way of non-limiting example, the first user or the second user adds a shirt to a pair of pants.

In some embodiments, the item for purchase is a first piece of clothing and the first user or the second user modifies the graphic representation of the first piece of clothing by adding an accessory to the graphic representation of the first piece of clothing. In some embodiments, the accessory is a hat, a belt, a pair of shoes, a scarf, a piece of jewelry, or a purse. In some embodiments, the accessory is a pair of shoes. (See FIG. 2)

### Communicating

In some embodiments, the first user and the second user interact in real-time. As used herein, “real-time” means communication in which information is received at (or nearly at) the instant it is sent. In some embodiments, the first user and the second user interact in non-real time. As used herein, “non real-time” means communication in which there is a delay between sending and receiving information.

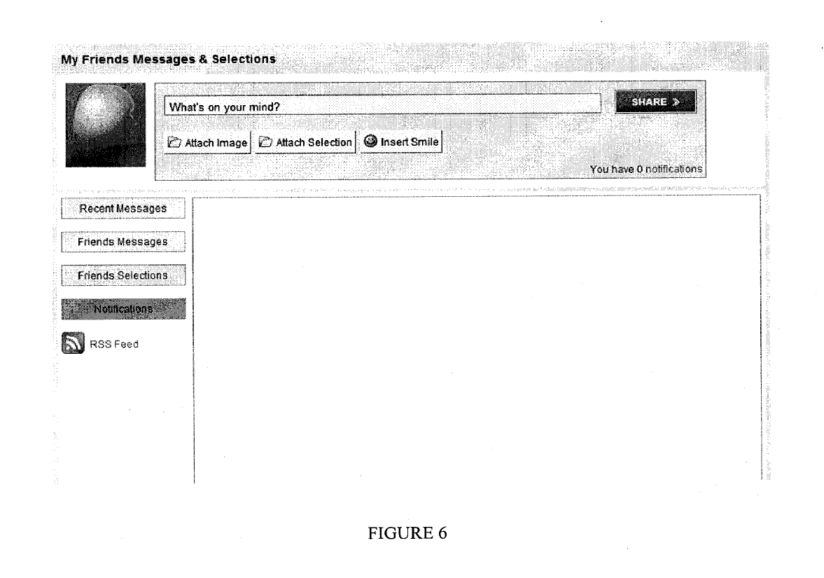

In some embodiments, the first user and the second user interact by a method selected from: email, webmail, chatting, messaging, instant messaging, posting a message (See FIG. 6; e.g., using a Tweet account, on Facebook, on MySpace), telephone, internet telephone (e.g., Skype), or a combination thereof.

In some embodiments, the first user provides a graphic representation of an item for purchase to the second user. In some embodiments, the method further comprises the second user recommending an item for purchase to the first user.

In some embodiments, the method further comprises the first user exporting the graphic representation of an item for purchase to a third party (e.g., a third party social interface). In some embodiments, the first user exports the graphic representation to Facebook, MySpace, Blogger, Delicious, Digg This, Google, Kaboodle, Linkedin, Microsoft Live, Plaxo, Propeller, Reddit, StumbleUpon, Tweet This, AIM, AIM Share, Amazon, Ask, Backflip, Ballhype, Bebo, Blogmarks, Buzz, Diigo, Fark, Faves, Friendfeed, kRISTY, Link-a-Gogo, Mister Wong, Mixx, Multiply, myAOL, Netvibes, Netvouz, Newsvine, Simpy, Slashdot, Spurl, Stylehive, Technorati, Thisnext, Tumblr, TypePad, WordPress, Y!Bookmarks.

### Reviews

In some embodiments, the method further comprises the first user or the second user evaluating (i) an item for purchase, (ii) a vendor (e.g., a reseller or manufacturer), (iii) a stylist, (iv) a personal shopper, or (v) a combination thereof. In some embodiments, the first user or the second user numerically ranks, positionally ranks, or reviews (i) an item for purchase, (ii) a vendor (e.g., a reseller or manufacturer), (iii) a stylist, (iv) a personal shopper, or (v) a combination thereof.

### Purchasing

In some embodiments, the method further comprises the first user or the second user purchasing at least one item for purchase. In some embodiments, the method further comprises the first user or the second user purchasing a plurality of items for purchase.

In some embodiments, the method further comprises the first user or the second user purchasing a plurality of items for purchase from a plurality of vendors. By way of non-limiting example, the first user or the second user purchases a pair of shoes from Jimmy Choo and a dress from Prada. In some embodiments, the user is able to purchase plurality of items for purchase from a plurality of vendors in a single transaction (e.g., using a single shopping cart).

In some embodiments, there is a “Buy” button next to each item for purchase. In some embodiments, the “Buy” button allows a user to place an item in a shopping cart. In some embodiments, the user reviews the items for purchase in the shopping cart before purchasing them. In some embodiments, a user is able to purchase the items for purchase with a single indication (e.g., by pushing a single button; i.e., the user does not need to enter personal information (e.g., shipping address or payment information).

In some embodiments, a hyperlink is associated with an item for purchase. In some embodiments, the hyperlink takes a user to a third-party website where the user is able to purchase the item for purchase.

### Notifications

In some embodiments, the method further comprises the interactive social shopping user interface notifying the first user or the second user of a sale (See FIG. 6). In some embodiments, the interactive social shopping user interface notifies the user when the user logs on. In some embodiments, the interactive social shopping user interface notifies the user by sending the user a message (See FIG. 6; e.g., an email, a text message, an instant message, a Tweet, a bulletin board posting, a Facebook wall posting, a MySpace posting).

In some embodiments, the method further comprises the interactive social shopping user interface notifying the first user or the second user of a coupon or discount code (See FIG. 6). In some embodiments, the interactive social shopping user interface notifies the user when the user logs on. In some embodiments, the interactive social shopping user interface notifies the user by sending the user a message (e.g., an email, a text message, an instant message, a Tweet, a bulletin board posting, a Facebook wall posting, a MySpace posting).

In some embodiments, the method further comprises the interactive social shopping user interface notifying the first user or the second user of a new item for purchase (See FIG. 6; e.g., the release of a new movie, music album, fashion collection (e.g., a spring collection)). In some embodiments, the interactive social shopping user interface notifies the user when the user logs on. In some embodiments, the interactive social shopping user interface notifies the user by sending the user a message (e.g., an email, a text message, an instant message, a Tweet, a bulletin board posting, a Facebook wall posting, a MySpace posting).

### Vendors

In some embodiments, the item for purchase is controlled by a vendor. In some embodiments, the vendor is a manufacturer/designer of the item for purchase or is a reseller (i.e., a company or individual that purchases items with the intention of selling them to a consumer rather than consuming or using the item) of the item for purchase. By way of non-limiting example, manufacturers/designers include Sony, Apple, Panasonic, Samsung, Gucci, Diesel, DKNY, La Perla, Calvin Klein, Christian Dior, Gap, Prada, Ralph Lauren, Nike Chloe, Dolce & Gabbana, Hugo Boss, Louis Vuitton, J. Crew, Banana Republic, Jimmy Choo, Betsy Johnson, Giorgio Armani, Elie Tahari, Salvatore Ferragamo, Champion, Just Cavalli, 7 For All Mankind, Roberto Cavalli, Lucky Jeans, Bottega Veneta, and Valentino. By way of non-limiting example, resellers include Macy's, Neiman Marcus, Saks Fifth Avenue, Nordstrom's, Target, Wal-Mart, Best Buy, Borders, Barnes & Nobel, Home Depot, and Lowe's.

### Personalizing Computer Module (e.g., a Computer Program)

In some embodiments, the method further comprises the first user or the second user customizing the social shopping networking service by inputting information into a personalized account (e.g., an account available only to a user with the correct log-in name and password).

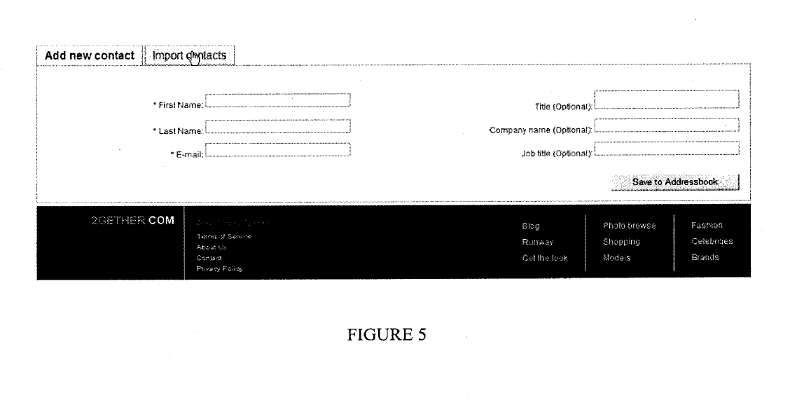

In some embodiments, the first user or the second user inputs information about a contact that enables the user to communicate with the contact (i.e., contact information; e.g., an email address). In some embodiments, the first user or the second user uploads information about a contact that enables the user to communicate with a contact (i.e., contact information). (See FIG. 5) In some embodiments, the first or second user imports information about a contact from an electronic address book (e.g., Microsoft Outlook, Gmail, Yahoo mail, AOL email).

In some embodiments, the first user or the second user inputs a shipping address. In some embodiments, the first user or the second user inputs a plurality of shipping addresses. In some embodiments, the first user or the second user inputs a default shipping address. In some embodiments, the first user or the second user inputs a preferred carrier (e.g., the USPS, UPS, FedEx). In some embodiments, the first user or the second user inputs a preferred method of shipping (e.g., priority, overnight, standard, airplane, ground).

In some embodiments, the first user or the second user inputs a billing address.

In some embodiments, the first user or the second user inputs a method of payment (e.g., check, online bill pay (e.g., Pay Pal), a credit card, or wire transfer).

In some embodiments, the first user or the second user inputs physical characteristics. In some embodiments, the first user or the second user inputs physical characteristics selected from: physical measurements (e.g., height, bust size, waste size), gender (e.g., male, female, unisex), age, or a combination thereof. In some embodiments, the first user or the second user inputs clothing sizes (e.g., 0, 2, 4, 6, 8, 10, 12, small, medium, large, x-large). In some embodiments, the first user or the second user inputs shoes sizes (e.g., narrow, wide, regular, 7, 7½, 8, 8½, 9, 9½). In some embodiments, the first user or the second user inputs accessory sizes (e.g., ring size, belt size, hat size).

In some embodiments, the first user or the second user inputs style preferences. In some embodiments, the first user or the second user inputs color preferences. In some embodiments, the first user or the second user inputs brand/manufacturer preferences (e.g., Gucci, Diesel, DKNY, La Perla, Calvin Klein, Christian Dior, Gap, Prada, Ralph Lauren, Nike Chloe, Dolce & Gabbana, Hugo Boss, Louis Vuitton, J. Crew, Banana Republic, Jimmy Choo, Betsy Johnson, Giorgio Armani, Elie Tahari, Salvatore Ferragamo, Champion, Just Cavalli, 7 For All Mankind, Roberto Cavalli, Lucky Jeans, Bottega Veneta, and Valentino).

### Social Shopping Toolbar

In some embodiments, the method further comprising the first user utilizing a social shopping toolbar, provided by a social shopping networking service. In some embodiments, the social interaction toolbar comprises a module adapted to create a selection of items for purchase, wherein said items for purchase are selected from one or more web sites; and a social interaction web application comprising a module adapted to enable at least a first and a second user to simultaneously view an identical item from said selection of items for purchase, such that a live showroom is generated, and a module that enables the first and second user to interact with each other.

A toolbar is a graphic user interface (GUI) element comprising, by way of non-limiting examples, onscreen text, images, icons, buttons, checkboxes, menus, text fields, or other input or output elements. Those of skill in the art will recognize that toolbars are found in a wide range of applications including office suites, graphics editors, web browsers, and the like. In some embodiments, the toolbar comprises a web browser plug-in, extension, add-in, or add-on. In other embodiments, the toolbar comprises a mobile application. In still other embodiments, the toolbar comprises a standalone application.

In some embodiments, the social interaction toolbar comprises a module adapted to create a selection of items for purchase, wherein said items for purchase are selected from one or more web sites, such as a website controlled by a vendor.

In various embodiments, the social interaction toolbar facilitates interaction regarding any items for purchase and comprises a module adapted to create a selection of items for purchase selected from any web site. In further embodiments, the social interaction toolbar is a social shopping toolbar and comprises a module adapted to create a selection of items for purchase for purchase, wherein said items for purchase are selected from one or more shopping web sites.

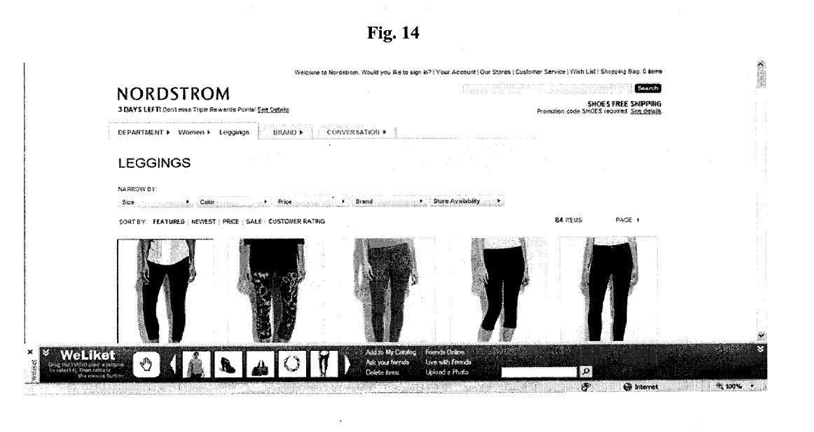

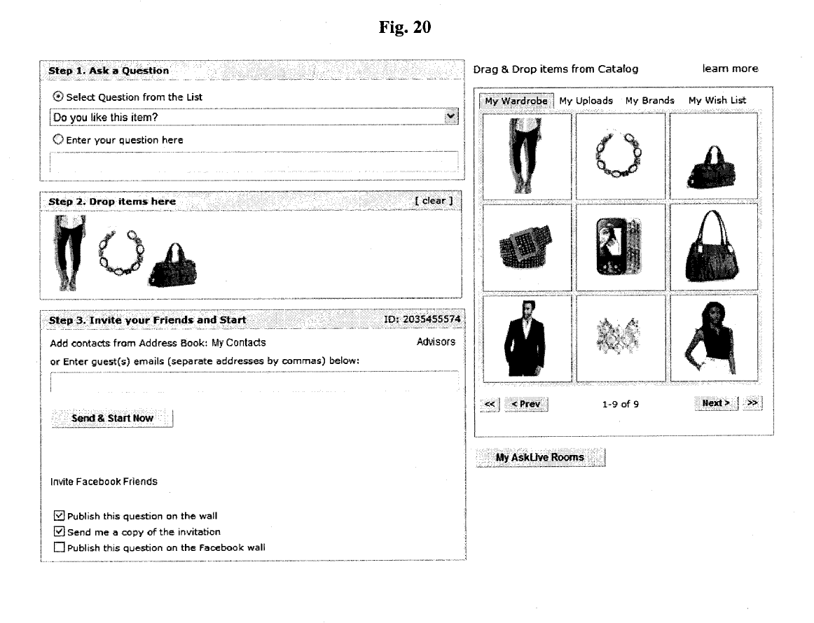

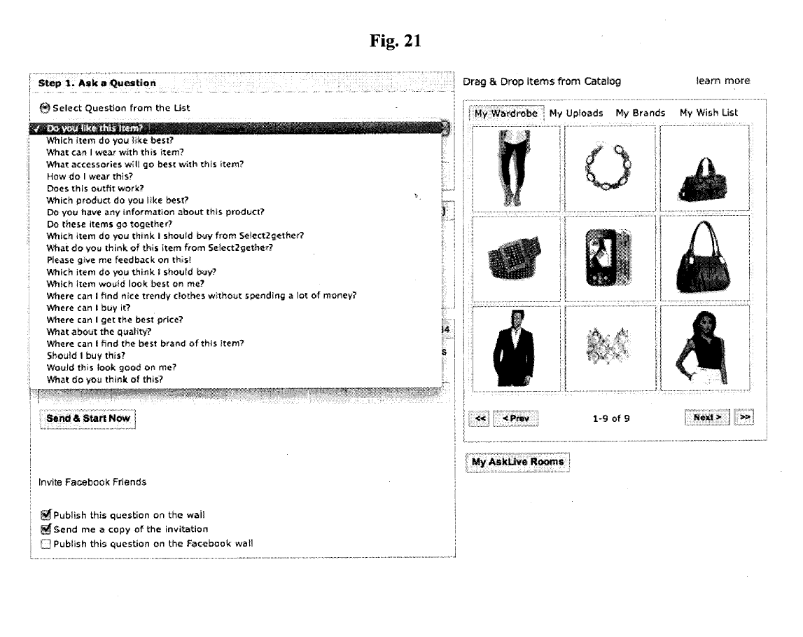

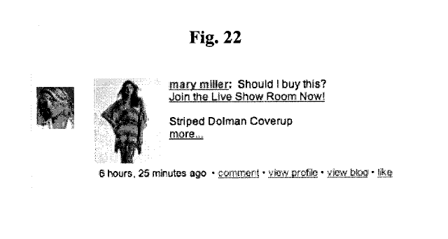

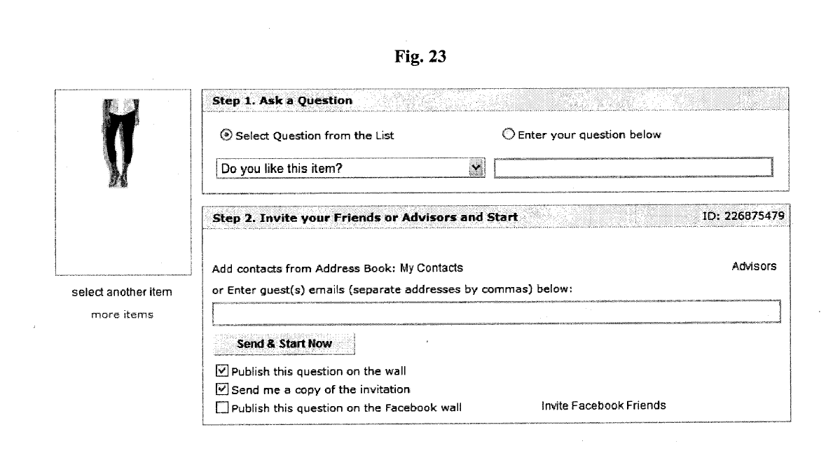

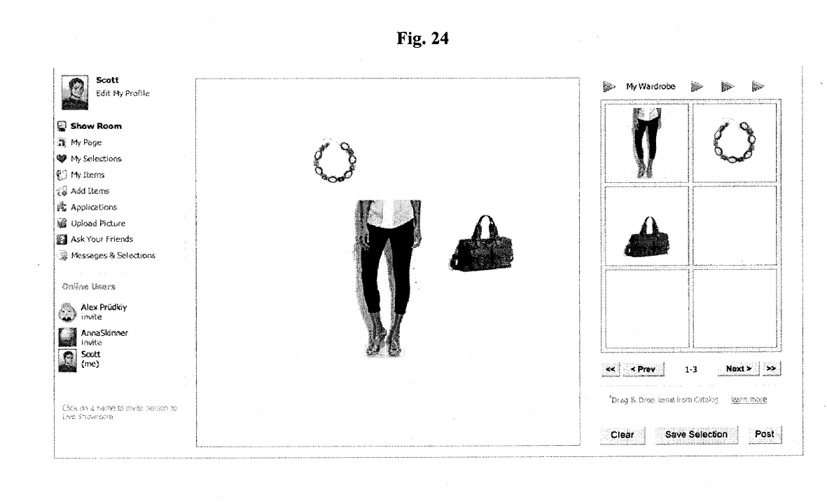

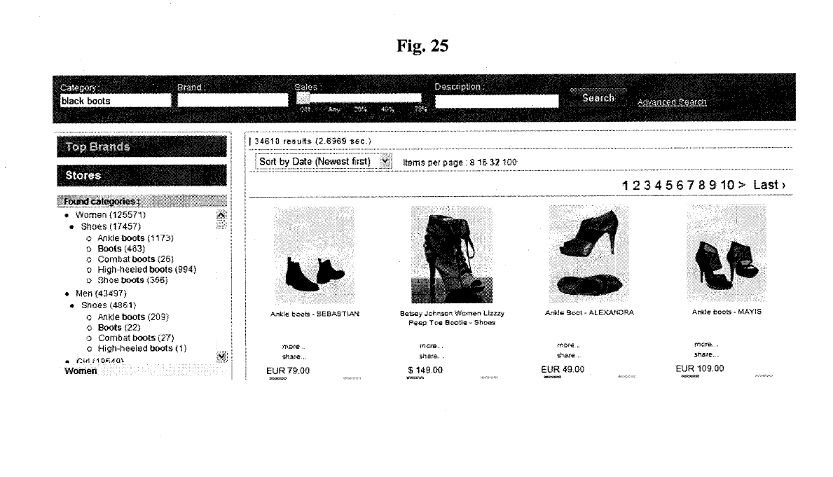

In some embodiments, each item is represented by a graphic representation. In some embodiments, the graphic representation of at least one item for purchase is a photograph. See FIGS. 14, 15, 16, 19, 20, 21, 22, 23, 24, and 25. In some embodiments, the graphic representation is a 3-dimensional graphic representation. In some embodiments, the graphic representation is a 2-dimensional graphic representation. In some embodiments, the graphic representation further comprises a graphic representation (e.g., avatar) of one or more users of the system. In some embodiments, each item is associated with a description. In some embodiments, the description comprises, by way of non-limiting examples, manufacturer, designer, vendor, provider, author, materials used to make the item, a manual describing how to use the item, color options, size options, or combinations thereof. In some embodiments, the description further comprises a module that enables a user to request additional information about the item. In some embodiments, each item is associated with a URI.

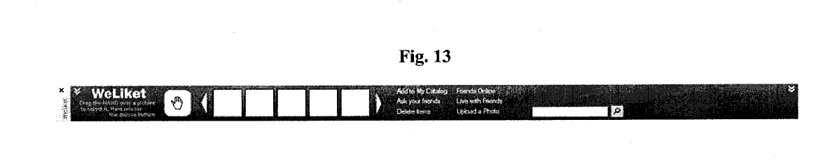

Referring to FIG. 13, in some embodiments, the toolbar is expandable and collapsible. In some embodiments, the toolbar is removable (e.g., closable) and restorable (e.g., re-openable). In some embodiments, the toolbar has GUI elements for searching for items for purchase, observing the online status of others, and interacting with others with regard to one or more items for purchase. In some embodiments, the social shopping toolbar includes a module adapted to create a selection of items for purchase from one or more web sites. In a particular embodiment, a user selects one or more items from one or more web sites by dragging an element of the toolbar (e.g., a hand icon, a crosshairs, an arrow, etc.) and dropping it over an item.

In other embodiments, a user selects one or more items by dragging an item to an element of the toolbar. In other embodiments, a user selects one or more items by typing a URI associated with each item. In various embodiments, the selection of items for purchase comprises up to 200, 150, 100, 50, 25, 10, or 5 items at any given time. In further embodiments, a user scrolls through a plurality of items by using arrow buttons, keyboard keys, or scroll bars.

Referring to FIG. 14, in some embodiments, the toolbar is anchored to the GUI of a web browser in such a way that it is available to a user when viewing any web site at any time. In further embodiments, the toolbar is detachable from the GUI of a web browser. In further embodiments, the toolbar floats over web site content. In some embodiments, the toolbar is expanded and/or collapsed by mouse click, touchscreen tap, touchscreen swipe, or keystroke to coordinate efficient use of screen real estate when shopping online.

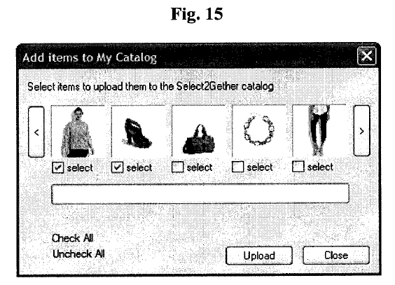

Referring to FIG. 15, in some embodiments, the toolbar further includes a module adapted to export one or more items from said selection of items for purchase to the social shopping web application. In a particular embodiment, the module is activated by a button or link on the toolbar and includes a scrollable list of selected items and checkboxes used to indicate items for export. In view of the disclosure herein, those of skill in the art will recognize that computer technologies offer many other ways to enable a user to indicate one or more items.

In some embodiments, the toolbar further includes a module adapted to export one or more items from said selection of items for purchase to a third party social network, social application, shopping forum, or communications forum. In further embodiments, the module exports one or more items to Facebook, MySpace, Blogger, Delicious, Digg This, Google, Kaboodle, LinkedIn, Microsoft Live, Plaxo, Propeller, Reddit, StumbleUpon, Tweet This, AIM, AIM Share, Amazon, Ask, Backflip, Bebo, Blogmarks, Buzz, Diigo, Fark, Faves, Friendfeed, kRISTY, Link-a-Gogo, Mister Wong, Mixx, Multiply, myAOL, Netvibes, Netvouz, Newsvine, Simpy, Slashdot, Spurl, Stylehive, Technorati, Thisnext, Tumblr, TypePad, WordPress, and/or Y!Bookmarks.

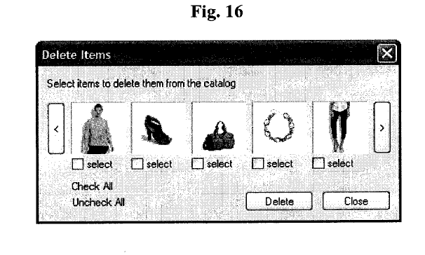

Referring to FIG. 16, in some embodiments, the toolbar includes a module adapted to create a selection of items for purchase that is further adapted to delete selected items. In a particular embodiment, the module is activated by a button or link on the toolbar and includes a scrollable list of selected items and checkboxes used to indicate items for deletion. In view of the disclosure herein, those of skill in the art will recognize that computer technologies offer many other ways to enable a user to indicate one or more items.

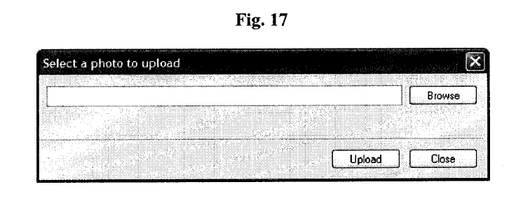

Referring to FIG. 17, in some embodiments, the toolbar includes a module adapted to create a selection of items for purchase that is further adapted to upload photos of selected items. In further embodiments, the photo is uploaded from a storage device connected to the digital processing device. In other embodiments, the photo is uploaded from, by way of non-limiting examples, the Internet, the web, the cloud, an intranet, a camera, or a phone. In some embodiments, the module is activated by a button or link on the toolbar and a user indicates photos for upload typing or browsing for a URI, filepath, or filename.

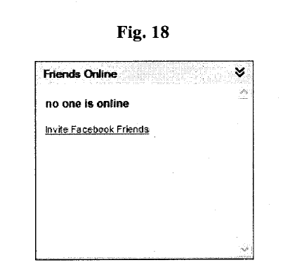

Referring to FIG. 18, in some embodiments, the toolbar includes a module adapted to monitor the online status of one or more friends or advisors. In a particular embodiment, the module is activated by a button or link on the toolbar and allows a user to monitor the online status of other users of the system described herein and/or users of a third party social network such as those described herein. In some embodiments, friends or advisors who are currently online are represented by a graphic representation (e.g., a photo or avatar) and or a name or screen name.

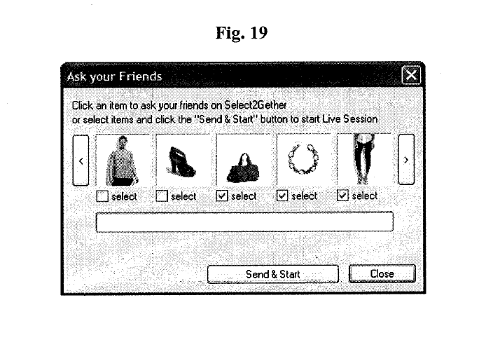

Referring to FIG. 19, in some embodiments, the toolbar includes a module adapted to query one or more friends or advisors regarding one or more items from a selection of items for purchase. In a particular embodiment, the module is activated by a button or link on the toolbar and includes a scrollable list of selected items and checkboxes used to indicate items for query. In view of the disclosure herein, those of skill in the art will recognize that computer technologies offer many other ways to enable a user to indicate one or more items. In further embodiments, the module is further adapted to initiate a live interaction. In still further embodiments, the module is further adapted to initiate a live interaction with one or more friends or advisors within a social shopping web application.

### Software

Further disclosed herein, in some embodiments, are computer programs embodied on computer readable media. Any and all of the features described herein are contemplated as additional software components.

In some embodiments, a program enables multiple purchases from different vendors on line, wherein each vendor requires different data points or fields to be completed.

In some embodiments, a program enables a user to shop at a plurality of different websites each having different field requirements for completing a sale or an on-line merchandise. In some embodiments, the web application automatically populates all relevant information for completing said sale. In some embodiments, the web application comprises a storage component which stores at least 1, 2, 5, or 10 pieces of data about the user. In some embodiments, the data is selected from: name, address, shipping address, credit card information, shirt size, pant size, height, weight, bust size, coupon information, birth date, color selections, shoe size, etc.

In some embodiments, a program enables shopping on line.

In some embodiments, a program enables commenting on a merchandise, publishing the merchandise and/or information on it to multiple individuals in user's “contacts” list, rating the product, reviewing the product, reading more information about the product, or communicating about the product with one or more other users.

### System

Additionally disclosed herein, in certain embodiments, is a system for interactive social shopping. In some embodiments, the system comprises: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

In some embodiments, the computer module (e.g., a computer program) that provides a selection of items for purchase generates a selection of items for purchase by analyzing the previous purchases of the first or second user. In some embodiments, the computer module (e.g., a computer program) that provides a selection of items for purchase generates a selection of items for purchase by purchase by analyzing the previous items for purchase viewed by the first or second user.

In some embodiments, the system further comprises a computer module (e.g., a computer program) that enables a user to select a contact with whom to interact. In some embodiments, the system further comprises a computer module (e.g., a computer program) that enables a user to a contact from members of the social shopping networking service. In some embodiments, the system further comprises a computer module (e.g., a computer program) that enables a user to search for a particular contact. In some embodiments, the system further comprises a computer module (e.g., a computer program) that enables the social networking service to suggest a contact.

In some embodiments, the system further comprises a computer module (e.g., a computer program) that enables a user to invite a contact to join the social shopping networking service. In some embodiments, the system further comprises a computer module (e.g., a computer program) that enables a user to import information about contacts (e.g., email addresses) from an electronic address book (e.g., Microsoft Outlook, Gmail, Yahoo mail, AOL email) or a list of contacts from a third party social networking service (e.g., Linkedin, Facebook, MySpace). (See FIG. 5)

In some embodiments, the system further comprises a computer module (e.g., a computer program) that enables the first and second user to export an image of an item for purchase (e.g., upload the image onto another social networking site, save the image onto a hard drive, email the image).

In some embodiments, the system further comprises a computer module (e.g., a computer program) that enables the first and second user to upload an image of an owned item.

In some embodiments, the system further comprises a computer module (e.g., a computer program) that enables the first and second user to evaluate (i.e., rate) an item for purchase, a vendor, or a combination thereof.

In some embodiments, the system further comprises a computer module (e.g., a computer program) that enables the first and second user to modify a graphic representation of at least one item for purchase.

In some embodiments, the system further comprises a computer module (e.g., a computer program) that enables the first and second user to purchase an item for purchase. In some embodiments, the computer module (e.g., a computer program) that enables the first and second user to purchase an item for purchase is in the form of a “Buy” button.

In some embodiments, the system further comprises a computer module (e.g., a computer program) that enables the first and second user to search for an item for purchase.

In some embodiments, the system further comprises a computer module (e.g., a computer program) that notifies the first and second user of a sale, a coupon, a discount code, a promotion, a new item for purchase, or a combination thereof.

In some embodiments, the system further comprises a computer module (e.g., a computer program) that enables the first and second user to calendar the date of an upcoming sale, item release, or a combination thereof.

In some embodiments, the system further comprises a computer module (e.g., a computer program) that enables the first and second user to enter and store personal information.

### Devices

Further disclosed herein, in certain embodiments, is a device for interactive social shopping, the device comprising: (a) a computer module (e.g., a computer program) that provides a selection of items for purchase, wherein each item is represented by a graphical representation; (b) a computer module (e.g., a computer program) that enables at least a first and a second user to simultaneously view an identical item for purchase, such that a live showroom is generated; and (c) a computer module (e.g., a computer program) that enables the first and second user to interact with each other.

In some embodiments, the device is a computer. As used herein, “computer” means a programmable device that receives input, stores and manipulates data, and provides output in a useful format.

In some embodiments, the device is a cell phone, a personal digital assistant (PDA), a handheld device, or a combination thereof. In some embodiments, the device is a cell phone. In some embodiments, the device is a smart phone or an android phone.

In some embodiments, the device further comprises volatile memory, non-volatile memory, or a combination thereof. In some embodiments, the device comprises volatile memory. In some embodiments, the volatile memory is random access memory (RAM), dynamic random access memory (DRAM), or static random access memory (SRAM). In some embodiments, the device comprises non-volatile memory. In some embodiments, the non-volatile memory is read-only memory, flash memory, a magnetic computer storage device (e.g., hard disks, floppy disks, and magnetic tape), or optical discs.

In some embodiments, the computer module (e.g., a computer program) that provides a selection of items for purchase generates a selection of items for purchase by analyzing the previous purchases of the first or second user. In some embodiments, the computer module (e.g., a computer program) that provides a selection of items for purchase generates a selection of items for purchase by purchase by analyzing the previous items for purchase viewed by the first or second user.

In some embodiments, the device further comprises a computer module (e.g., a computer program) that enables the first and second user to evaluate an item for purchase, a vendor, or a combination thereof.

In some embodiments, the device further comprises a computer module (e.g., a computer program) that enables the first and second user to modify a graphic representation of at least one item for purchase.

In some embodiments, the device further comprises a computer module (e.g., a computer program) that enables the first and second user to purchase an item for purchase.

In some embodiments, the device further comprises a computer module (e.g., a computer program) that enables the first and second user to search for an item for purchase.

In some embodiments, the device further comprises a computer module (e.g., a computer program) that notifies the first and second user of a sale, a coupon, a discount code, a promotion, a new item for purchase, or a combination thereof.

In some embodiments, the device further comprises a computer module (e.g., a computer program) that enables the first and second user to calendar the date of an upcoming sale, item release, or a combination thereof.

In some embodiments, the device further comprises a computer module (e.g., a computer program) that enables the first and second user to enter and store personal information.

### Business Methods

Disclosed herein, in certain embodiments, is a business method that provides a virtual shopping environment to customers in exchange for a commission. In some embodiments, the method comprises enabling a user to shop for an item for purchase derived from a third party. In some embodiments, the method comprises enabling a user to review an item for purchase derived from a third party. In some embodiments, the method comprises enabling multiple users to shop together in a virtual environment. In some embodiments, the method comprises collecting a commission from each sale that occurs. In some embodiments, the method comprises allowing third parties to advertise products or services collecting revenues for (a) allowing an advertisement, (b) the number of users that view the advertisement, or (c) a combination thereof.

Disclosed herein, in certain embodiments, is a business method comprising: collecting commission for a sale resulting from interaction of two or more internet users sharing information about a merchandise available on line.

Disclosed herein, in certain embodiments, is a business method comprising licensing to an online merchant a web application that allows two or more users to exchange information about a merchandise available on line by said online merchant.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### EXAMPLES

### Example 1

A first user launches a web-browser from a desktop computer. The user types in the email address select2gether.com. After the website has loaded, the user enters the user's log-in name and password. The user searches for a dress. The user further specifies that the dress should be black. The user selects a dress for further review. The user searches for a pair of black high heels. The user selects two pairs of shoes for further review. The user then places the dress and both pairs of shoes in the user's live showroom. The user contacts a second user from users that are online and asks the second user to evaluate which shoes look best with the dress. The user then exports the image of the dress and both pairs of shoes to the user's Facebook wall. The user asks Facebook contacts for their opinion.

### Example 2

A first user launches a web-browser from a desktop computer. The user types in the email address select2gether.com. After the website has loaded, the user enters the user's log-in name and password. The user searches for a sofa. The user further specifies that the sofa should be white or beige. The user selects a sofa from Bassett for further review. The user searches for throw pillows. The user selects a pillow from Pier One for further review. The user then places the sofa and pillow in the user's live showroom. The user contacts a second user from users that are online and asks the second user to evaluate the sofa, pillow, and the combination of both. The user then places the sofa and three of the pillows in the users shopping cart. The user buys the items in one transaction.

### Example 3

A first user launches a web-browser from a smart cell phone. The user types in the email address select2gether.com. After the website has loaded, the user enters the user's log-in name and password. The user searches for a television. The user further specifies that the television should be manufactured by Panasonic or Samsung. The user selects a Samsung television for further review. The user contacts a product advisor that is online and asks the product advisor for information about the television. The user purchases the television.

### Example 4

A first user opens Microsoft® Internet Explorer® on a laptop computer and visits www.select2gether.com. By clicking on a hyperlink, the user downloads an executable application. The executable application installs an explorer bar constituting a social shopping toolbar. The toolbar stays at the bottom of the GUI of the web browser and is available while viewing any web site. The toolbar is optionally and reversibly collapsible and optionally and reversibly removable. The toolbar is part of a larger social shopping networking service and offers features and modules that communicate with a social shopping web application, which is also part of the service. The toolbar includes a module adapted to create a selection of items, wherein said items are selected from one or more web sites, a module adapted to query one or more friends or advisors regarding one or more items from a selection of items, and a module adapted to search previously selected items.

### Example 5

The first user described in Example 4, visits a retail apparel shopping web site and selects a sweater by dragging a hand icon on the toolbar over an image of the sweater and releasing the icon. The image of the sweater is added to the module adapted to create a selection of items. The image of the sweater appears on the toolbar and the URI of the sweater's information is captured by the toolbar. The user then activates a module of the toolbar adapted to query one or more friends or advisors regarding one or more items. The user drags the photo of the sweater to a designated area of the GUI to indicate that the sweater is the subject of the query and the user activates a pull-down menu and selects a pre-configured question; namely, would this look good on me? The user quickly glances at a module of the toolbar adapted to monitor the online status of friends, contacts, and advisors. Seeing that a second user of the system is online, the first user indicates that the second user should receive the query.

### Example 6

The friend described in Example 5, receives an email with an invitation to join a live showroom to view and discuss the sweater. The message includes the photo of the sweater, a photo of the first user, and the text of the query. The second user clicks a hyperlink in the email to enter a social shopping web application including modules adapted to enable simultaneous viewing of an identical item and live interaction between multiple users. The first and second users simultaneously view the sweater and discuss it via instant messaging. The second user uploads a photo of a pair of black shoes that would complement the sweater. The users further discuss the collaboratively forming ensemble.

What is claimed is:

1. A computer-implemented method for interactive social shopping, comprising:
a) a social shopping networking service providing an interactive social shopping user interface to at least a first user and a second user;
b) the interactive social shopping user interface providing to the first user and the second user (i) a computer module (e.g., a computer program) that provides a selection of items for purchase, (ii) a computer module (e.g., a computer program) that enables the first user and the second user to simultaneously view a graphic representation of an item for purchase, and (iii) a computer module (e.g., a computer program) that enables at least the first user and the second user to interact with each other; and
c) the first user and the second user launching the interactive social shopping user interface.

2. The method of claim 1, wherein:
a) the first user launches the interactive social shopping user interface from a first computer and the second user launches the interactive social shopping user interface from a second computer;
b) the first user and the second user simultaneously view at least one identical item for purchase from the selection provided by the interactive social shopping user interface, such that a live showroom is generated; and
c) the first user and the second user interact with each other in real time.

3. The method of claim 1, further comprising the interactive social shopping user interface generating a list of items for purchase by analyzing the previous purchases of the first user or the second user.

4. The method of claim 1, further comprising the interactive social shopping user interface generating a list of items for purchase by analyzing the previous items for purchase viewed by the first user or the second user.

5. The method of claim 1, wherein the graphic representation of at least one item for purchase further comprises a graphic representation of the first user or the second user.

6. The method of claim 1, wherein the second user is: a vendor representative, a personal shopper, a sales consultant, a friend, or a combination thereof.

7. The method of claim 1, further comprising the first user launching a social shopping toolbar, provided by the social shopping networking service, and populating the toolbar with at least one item for purchase.

8. The method of claim 8, wherein the first user contacts the second user by selecting the second user from a menu on the toolbar.

9. The method of claim 1, wherein the first user and the second user interact by a method selected from: email, webmail, chatting, messaging, instant messaging, posting a message, telephone, internet telephone, or a combination thereof.

10. The method of claim 1, wherein the first user provides a graphic representation of an item for purchase to the second user.

11. The method of claim 1, further comprising the second user recommending an item for purchase to the first interactive user.

12. The method of claim 1, further comprising the first user exporting the graphic representation of an item for purchase to a third party social interface.

13. The method of claim 1, further comprising the first user or the second user purchasing at least one item for purchase.

14. The method of claim 1, further comprising the first user or the second user searching for an item for purchase, wherein the searching is through a searching computer module (e.g., a computer program) provided by the interactive social shopping user interface.

15. The method of claim 18, wherein the search term is a designer, a manufacturer, a vendor, a color, a size, a price, a class of items for purchase, a numerical rating, a positional rating, or a combination thereof.

16. The method of claim 1, further comprising the interactive social shopping user interface notifying the first user or the second user of a sale.

17. The method of claim 1, further comprising the interactive social shopping user interface notifying the first user or the second user of a coupon or discount code.

18. The method of claim 1, further comprising the interactive social shopping user interface notifying the first user or the second user of a new item for purchase.

19. The method of claim 1, further comprising the first user or the second user customizing the interactive social shopping user interface by inputting information.

20. The method of claim 19, wherein the first user or the second user inputs a shipping address, billing address, a method of payment, physical characteristics, clothing sizes, shoes sizes, accessory sizes, style preferences, color preferences, brand preferences, or any combination thereof.

21. A system for interactive social shopping, comprising:
a) a computer module (e.g., a computer program) that provides a selection of items for purchase, wherein each item is represented by a graphical representation;
b) a computer module (e.g., a computer program) that enables at least a first and a second user to simultaneously view an identical item for purchase, such that a live showroom is generated; and
c) a computer module (e.g., a computer program) that enables the first and second user to interact with each other.

22. The system of claim 21, wherein the computer module (e.g., a computer program) that provides a selection of items for purchase generates a selection of items for purchase by analyzing the previous purchases of the first or second user.

23. The system of claim 21, wherein the computer module (e.g., a computer program) that provides a selection of items for purchase generates a selection of items for purchase by purchase by analyzing the previous items for purchase viewed by the first or second user.

24. The system of claim 21, further comprising a computer module (e.g., a computer program) that enables the first and second user to purchase an item for purchase.

25. The system of claim 21, further comprising a computer module (e.g., a computer program) that enables the first and second user to search for an item for purchase.

26. The system of claim 21, further comprising a computer module (e.g., a computer program) that notifies the first and second user of a sale, a coupon, a discount code, a promotion, a new item for purchase, or a combination thereof.

27. The system of claim 21, further comprising a computer module (e.g., a computer program) that enables the first and second user to calendar the date of an upcoming sale, item release, or a combination thereof.

28. The system of claim 21, further comprising a computer module (e.g., a computer program) that enables the first and second user to enter and store personal information.

29. A computer-implemented method for creating a social shopping networking service, comprising:
(a) providing a first user with a computer program including executable instructions that create a social shopping toolbar comprising a module adapted to create a selection of items from one or more web sites; and
(b) providing said first user and at least a second user with a computer program including executable instructions that create a social shopping web application comprising a module adapted to simultaneously view an identical item from said selection of items, such that a live showroom is generated, and a module that enables said users to interact with each other.

30. The method of claim 29, wherein said first user selects one or more items by dragging an element of said toolbar and dropping it over an item.

31. The method of claim 29, wherein said first user selects one or more items by dragging an item to an element of said toolbar.

32. The method of claim 29, wherein said first user selects one or more items by specifying a graphic representation to upload.

33. The method of claim 29, wherein said first user selects one or more items by typing a URI.

34. The method of claim 29, wherein said selection of items comprises up to 200 items at any given time.

35. The method of claim 29, wherein said selection of items comprises up to 100 items at any given time.

36. The method of claim 29, wherein said selection of items comprises up to 50 items at any given time.

37. The method of claim 29, wherein said interaction between users is initiated by said first user querying at least said second user regarding one or more items from said selection of items.

38. A computer-based system for social shopping, comprising:
(a) a digital processing device comprising an operating system configured to perform executable instructions, wherein said processing device is optionally connected to a computer network; and
(b) a computer program including executable instructions that create a social shopping networking service comprising:
(i) a social shopping toolbar comprising a module adapted to create a selection of items for purchase, wherein said items are selected from one or more web sites; and
(ii) a social shopping web application comprising a module adapted to enable at least a first and a second user to simultaneously view an identical item for purchase from said selection of items for purchase, such that a live showroom is generated, and a module that enables the first and second user to interact with each other.

39. The system of claim 38, wherein said toolbar comprises a mobile application.

40. The system of claim 38, wherein said toolbar comprises a standalone application.

41. The system of claim 38, wherein said toolbar is available to a user when viewing any web site.

42. The system of claim 38, wherein said toolbar further comprises a module adapted to export one or more items from said selection of items to said social shopping web application.

43. The system of claim 38, wherein said toolbar further comprises a module adapted to export one or more items from said selection of items to a third party social network.

44. The system of claim 38, wherein said selection of items comprises URIs of the items or graphic representations of the items

45. The system of claim 38, wherein said toolbar further comprises a module adapted to monitor the online status of one or more friends or advisors.

46. The system of claim 38, wherein said toolbar further comprises a module adapted to query one or more friends or advisors regarding one or more items for purchase from said selection of items for purchase.

47. The system of claim 38, wherein said toolbar further comprises a module adapted to exchange information with said web application.

48. The system of claim 38, wherein said module that enables the first and second user to interact with each other is configured to enable one or more shoppings selected from: email, chat, instant messaging, SMS, MMS, blogging, microblogging, BBS posts, social networking, wall posts, screen sharing, video conferencing, or VoIP.
